(19) United States
(12) Patent Application Publication
(10) Pub. No.: US 2026/0091529 A1
(43) Pub. Date: Apr. 2, 2026

(54) MACHINING TOOL HAZARD MITIGATION SYSTEM

(71) Applicant: JPW Industries Inc., LaVergne, TN (US)

(72) Inventor: Yi-Feng Fang, Taichung City (TW)

(21) Appl. No.: 19/345,467

(22) Filed: Sep. 30, 2025

Related U.S. Application Data
(60) Provisional application No. 63/701,287, filed on Sep. 30, 2024.

(51) Int. Cl. B27B 5/38; B23D 59/00

(52) U.S. Cl. CPC B27B 5/38; B23D 59/001

(57) ABSTRACT

A machining tool as disclosed herein includes a frame, a work surface, a motor, and a working element positioned adjacent the work surface. A hazard mitigation system may be coupled to the working element and includes a support arm pivotally mounted to the frame, a retention structure biasing the support arm in a deployed position, and a braking or clutch mechanism operable to selectively transfer rotational kinetic energy of the motor or working element to the support arm. When actuated, the braking mechanism overcomes the retention structure and causes the support arm to pivot so the working element retracts beneath the work surface. In certain embodiments, the braking mechanism comprises a roller or sprag clutch actuated by a solenoid, optionally driven by a capacitor discharge circuit to achieve rapid engagement.

### CROSS-REFERENCES TO RELATED APPLICATIONS

This application claims priority to U.S. Provisional Patent Application Ser. No. 63/701,287 filed Sep. 30, 2024, the entirety of which is incorporated by reference herein.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

### 1. Field of the Invention

The present disclosure relates generally to machining tools. More particularly, the present disclosure pertains to protective systems and methods for mitigating hazardous situations involving a human object relative to a hazardous element of the machining tool.

### 2. Description of the Prior Art

A number of different machining tools exist to facilitate forming a work piece into a desired shape. These machining tools present a safety concern because the working element of these machining tools is typically very sharp and moves at a high rate of speed. Accordingly, severe injury such as severed digits and deep lacerations can occur if an operator contacts the working element of the machining tool. A number of different safety systems have been developed for machining tools in response to the dangers inherent in an exposed working element moving at high speed. Such safety systems are operable to trigger a reaction or stoppage device upon detecting or sensing the proximity or contact of some appendage of an operator with the working element of the machining tool. Current reaction or stoppage devices for machining tools suffer from issues such as complexity, user errors, complex maintenance procedures, calibration, slow speed of activation, and durability.

### BRIEF SUMMARY

In view of at least some of the above-referenced problems associated with machining tools, an exemplary object of the present disclosure may be to provide a new machining tool with hazard detection system and a hazard mitigation system. The hazard detection and mitigation systems are proposed to protect a body part of an operator from accidentally coming into contact with a running blade or working element of the machining tool, which can result in serious injury. The proposed solution may feature a non-contact hazard detection mechanism that triggers a safety response by stopping and/or retracting the blade. The key advantage of this solution is that it generates a safety response before the operator's hand makes contact with the active working element by at least retracting the working element beneath the work surface using the kinetic energy from the working element and motor. The total response time, including hazard detection and mitigation, may be less than 100 milliseconds.

In a particular embodiment, an exemplary machining tool as disclosed herein may include a frame, a work surface, a working element, a motor, and a hazard mitigation system operatively connected to the working element. The work surface may be positioned above the frame. The working element may be positioned adjacent to the work surface. The motor may be supported by the frame and operatively connected to the working element. The hazard mitigation system may include a support arm, a retention structure, and a braking mechanism. The support arm may be rotatably coupled to the working element and pivotally coupled to the frame. The support arm may be configured to allow the working element to retract beneath the work surface. The retention structure may be configured to bias the support arm in a deployed position relative to the frame. The braking mechanism may be operable to selectively transfer rotational kinetic energy of the working element and/or the motor to the support arm. Engagement of the braking mechanism may overcome the retention structure and cause the support arm to pivot such that the working element retracts beneath the work surface.

In an exemplary aspect according to the above-referenced embodiment, the machining tool may further include a pivot rod coupled to the frame. The support arm may be rotatably disposed on the pivot rod and the braking mechanism may be disposed on the pivot rod.

In an exemplary aspect according to the above-referenced embodiment, the machining tool may further include an arbor pulley, a motor pulley, at least one intermediate pulley, and one or more belts coupled between the motor pulley, the arbor pulley, and the at least one intermediate pulley. The arbor pulley may be coupled to the working element. The motor pulley may be coupled to the working element. The at least one intermediate pulley may be rotatably mounted to the pivot rod.

In an exemplary aspect according to the above-referenced embodiment, the at least one intermediate pulley may be coupled to the braking mechanism with rotation of the at least one intermediate pulley controlled by the braking mechanism.

In an exemplary aspect according to the above-referenced embodiment, the at least one intermediate pulley may be rotatable about the pivot rod when the braking mechanism is in a disengaged position. The at least one intermediate pulley may be fixed relative to the pivot rod when the braking mechanism is in an engaged position.

In an exemplary aspect according to the above-referenced embodiment, the braking mechanism may comprise an electromagnetic clutch, roller clutch, or sprag clutch disposed on the pivot rod and may be configured to engage the at least one intermediate pulley to release the retention structure and permit rotation of the support arm.

In an exemplary aspect according to the above-referenced embodiment, the machining tool may further include a hazard detection system and a controller operatively connected to the hazard mitigation system and the hazard detection system. The hazard detection system may be operable to track a position of a human body part relative to the working element. The controller may be configured to identify a hazardous situation based on outputs from the hazard detection system; and actuate the hazard mitigation system in response to the identified hazardous situation.

In an exemplary aspect according to the above-referenced embodiment, the retention structure may be a ball-and-spring mechanism.

In an exemplary aspect according to the above-referenced embodiment, the support arm may include a proximal end around which the support arm pivots and a distal end supporting the working element. The retention structure may be coupled closer to the distal end than to the proximal end.

In an exemplary aspect according to the above-referenced embodiment, the support arm may rotate less than thirty degrees (30°) between the deployed position and a retracted position.

In an exemplary aspect according to the above-referenced embodiment, the braking mechanism may further include a roller clutch, a lever, and a solenoid. The roller clutch may be configured to selectively stop rotation of at least one intermediate pulley. The lever may be coupled to the roller clutch and configured to selectively engage the roller clutch for stopping the at least one intermediate pulley. The solenoid may be coupled to the frame and configured to selectively engage the lever to control the roller clutch between an engaged position and a disengaged position.

In an exemplary aspect according to the above-referenced embodiment, the at least one intermediate pulley may be freely rotatable when the roller clutch is in the disengaged position and may be stopped when the roller clutch is in the engaged position.

In an exemplary aspect according to the above-referenced embodiment, the roller clutch may include a n inner race, an outer race, a plurality of rollers, and a roller cage. The plurality of rollers may be positioned between the inner race and the outer race. The roller cage may be configured to rotate less than about ten degrees to force the plurality of rollers into engagement between the inner race and the outer race.

In another particular embodiment, an exemplary hazard mitigation assembly for a machining tool as disclosed herein may include a pivot rod, a support arm, a retention structure, a clutch mechanism, and an actuator. The pivot rod may be configured to be supported by a frame. The support arm may be rotatably mounted on the pivot rod and configured to carry a working element. The retention structure may be configured to bias the support arm in a deployed position relative to the frame. The clutch mechanism may be disposed on the pivot rod and coupled to at least one intermediate pulley operatively coupled to the working element. The actuator may be operable to engage the clutch mechanism to stop rotational movement of the at least one intermediate pulley such that rotational kinetic energy of the working element is transferred to the support arm to overcome the retention structure and pivot the support arm to a retracted position.

In an exemplary aspect according to the above-referenced embodiment, the clutch mechanism may comprise a roller clutch including an inner race, an outer race, and a roller cage configured to shift less than ten degrees to force rollers into engagement between the inner race and the outer race.

In an exemplary aspect according to the above-referenced embodiment, the actuator may comprise a solenoid operatively connected to a lever coupled to the clutch mechanism. The solenoid may be configured to move the lever for controlling the clutch mechanism between a disengaged position in which the at least one intermediate pulley rotates freely and an engaged position in which the at least one intermediate pulley is stopped.

In an exemplary aspect according to the above-referenced embodiment, the hazard mitigation assembly may further include a capacitor discharge circuit electrically connected to the solenoid and configured to momentarily overdrive the solenoid to reduce an engagement time of the clutch mechanism to less than 15 milliseconds.

In another particular embodiment, an exemplary method of mitigating hazards in a machining tool as disclosed herein may include operating a motor to drive a working element relative to a work surface; detecting a hazardous situation using a hazard detection system; actuating a clutch mechanism to stop an intermediate pulley of the machining tool, the intermediate pulley operatively coupled between the working element and the motor; transferring rotational kinetic energy of the working element through the clutch mechanism to a support arm, the support arm coupled to the working element; and pivoting the support arm to retract the working element beneath the work surface.

In an exemplary aspect according to the above-referenced embodiment, the support arm may be biased in a deployed position by a retention structure comprising a ball-and-spring mechanism, and pivoting the support arm may comprise overcoming the retention structure to release the support arm.

In an exemplary aspect according to the above-referenced embodiment, actuating the clutch mechanism may comprise energizing a solenoid operatively connected to a lever of a roller clutch to move the roller clutch between a disengaged position and an engaged position relative to the intermediate pulley.

### BRIEF DESCRIPTION OF THE SEVERAL VIEWS OF THE DRAWINGS

FIG. 1 is a block diagram of a machining tool in accordance with the present disclosure.

FIG. 2 is a perspective view of an embodiment of a machining tool in accordance with the present disclosure.

FIG. 3 is a top plan view of the machining tool of FIG. 2 in accordance with the present disclosure.

FIG. 4 is a side elevation view of the machining tool of FIG. 2 in accordance with the present disclosure.

FIG. 5 is an enlarged perspective view of the machining tool of FIG. 2 in accordance with the present disclosure.

FIG. 6 is a perspective view of an embodiment of the machining tool of FIG. 2 with force arrows representing a normal operation in accordance with the present disclosure.

FIG. 7 is a perspective view of the machining tool of FIG. 6 with force arrows representing a retraction operation in accordance with the present disclosure.

FIG. 8 is a perspective view of the machining tool of FIG. 2 including a dust chute in accordance with the present disclosure.

FIG. 9 is a side elevation view of the machining tool of FIG. 2 in a raised position in accordance with the present disclosure.

FIG. 10 is a side elevation view of the machining tool of FIG. 2 in a lowered position in accordance with the present disclosure.

FIG. 11 is a top plan view of the machining tool of FIG. 2 in accordance with the present disclosure.

FIG. 12 is a side elevation view of an embodiment of a machining tool in accordance with the present disclosure.

FIG. 13 is a perspective view of the machining tool of FIG. 12 in accordance with the present disclosure.

FIG. 14 is a cross-sectional side view of an embodiment of a hazard mitigation assembly of the machining tool of FIG. 12 in accordance with the present disclosure.

FIG. 15 is a cross-sectional front view of a clutch mechanism of the hazard mitigation assembly of FIG. 14 in a first position in accordance with the present disclosure.

FIG. 16 is a cross-sectional front view of a clutch mechanism of the hazard mitigation assembly of FIG. 14 in a second position in accordance with the present disclosure.

FIG. 17 is a is a cross-sectional front view of a clutch mechanism of the hazard mitigation assembly of FIG. 14 in a third position in accordance with the present disclosure.

FIG. 18 is an enlarged cross-sectional view of a roller of the clutch mechanism of FIG. 17 in an engaged position in accordance with the present disclosure.

FIG. 19 is a circuit diagram of a capacitor discharge circuit configured to drive a solenoid of the hazard mitigation assembly of FIG. 14 in accordance with the present disclosure.

FIG. 20 is a flow chart of a method of mitigating hazards in a machining tool in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

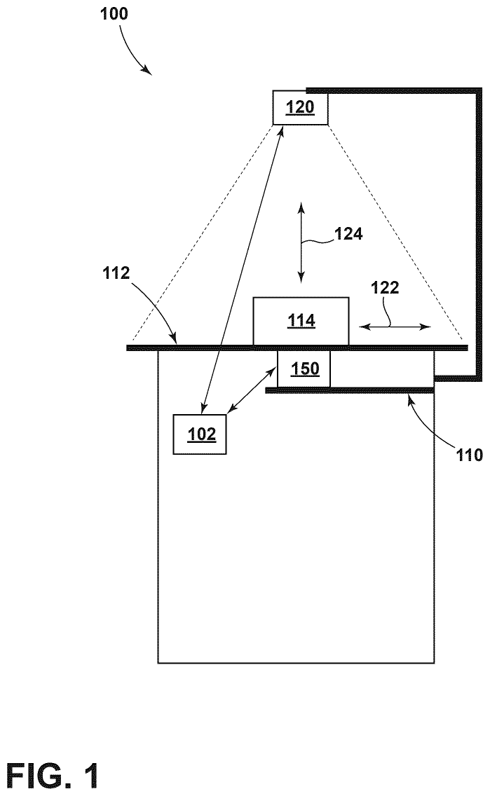

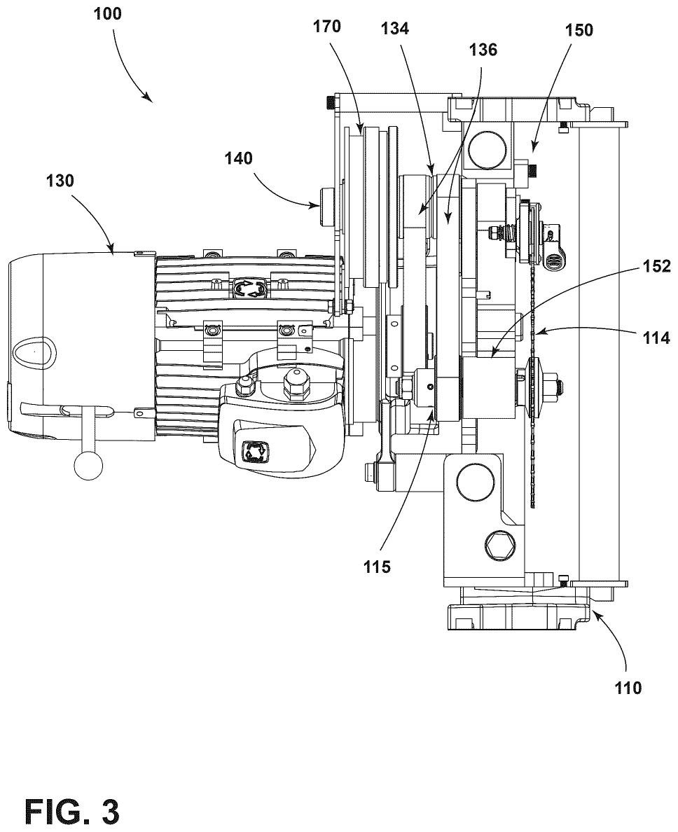

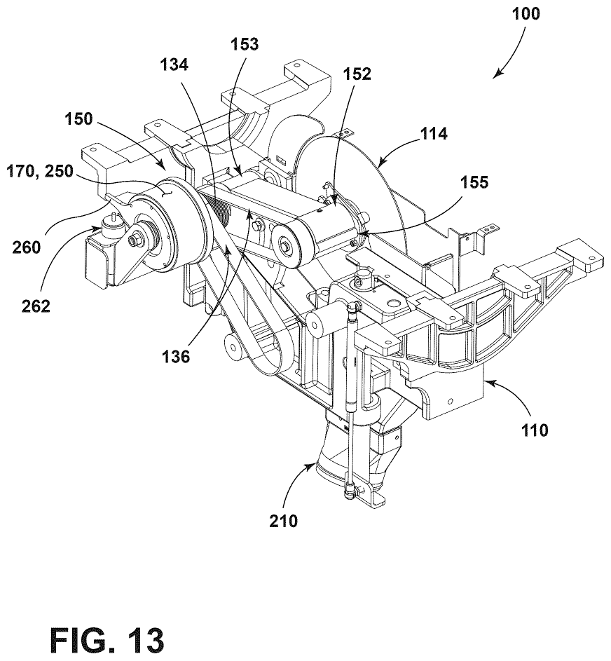

Referring to FIGS. 1-13, a machining tool 100 is provided. The machining tool 100 may include a frame 110, a work surface 112 positioned above the frame 110, and a working element 114 supported by the frame 110 and positioned adjacent or proximate to a work surface 112 of the machining tool 100. In certain optional and nonlimiting embodiments, the machining tool 100 may, for example, be a table saw, a router table, a planar, a jointer, a rip saw, a panel saw, or the like. As such, the working element 114 may be a saw blade, planar blade, a router bit, or some other sharp implement configured to interact with a work piece, such as wood, metal, or the like.

The machining tool 100 may further include a hazard detection system 120 positioned proximate to the working element 114. The hazard detection system 120 may be configured to track a position of a human body part relative to the working element 114. As illustrated in FIG. 1, the hazard detection system 120 may be configured to detect a hazardous condition between the at least human body part and the working element 114. In some embodiments, the hazard detection system 120 can be operable to track or monitor a position of at least one human body part relative to the working element 114 to determine when the at least one human body part is in a dangerous position. In some embodiments, the hazard detection system 120 may be operable to track or monitor the position of the at least one human body part in at least one first direction and/or at least one second direction. The at least one first direction 122 may be parallel to the work surface 112 and the at least one second direction 124 may be perpendicular to the work surface 112. The human body part may, for example, be a hand, arm, or some other appendage that may accidentally contact the working element 114. In other embodiments, other hazard detection systems can be implemented, including systems operable to detect contact between the working element 114 and the human body part, or generally detect when the human body part is in a dangerous condition with respect to the working element 114.

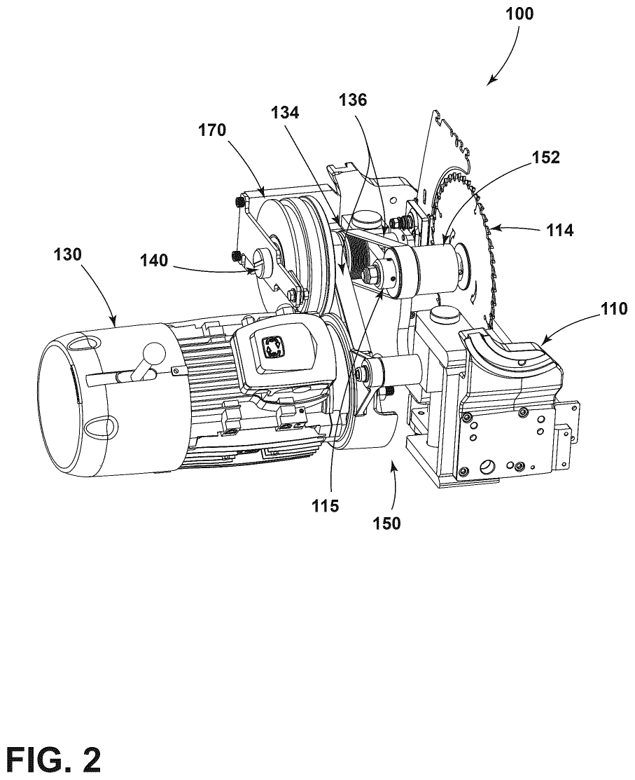

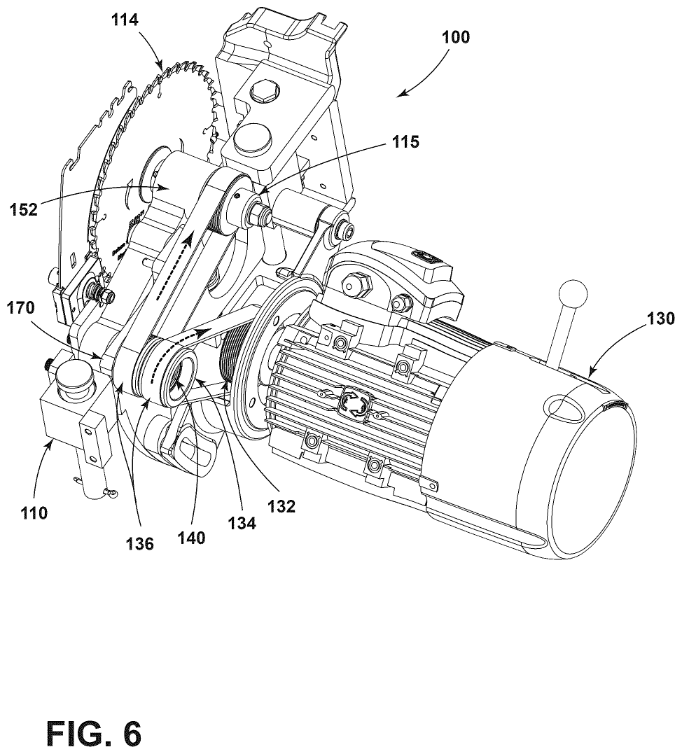

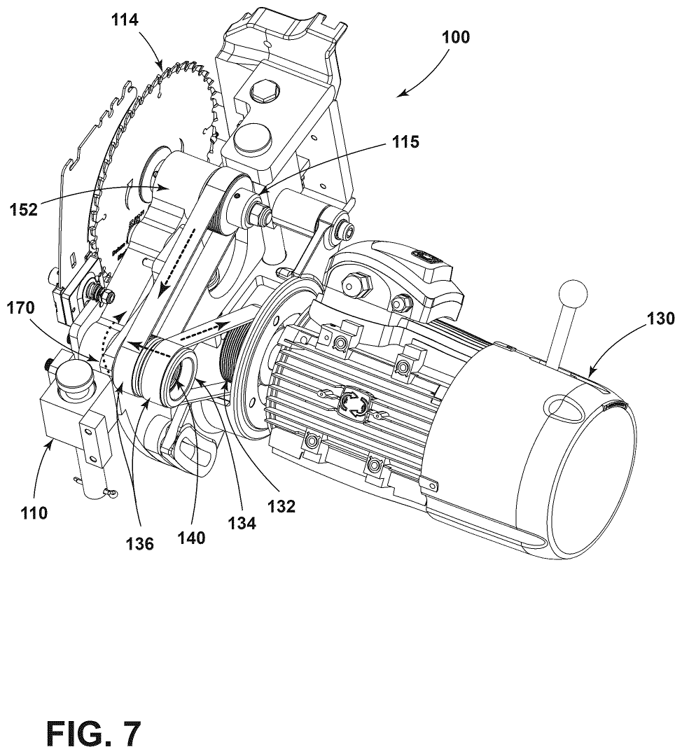

As illustrated in FIGS. 2-3 and 6-7, the machining tool 100 may further include a motor 130 having a motor pulley 132 (FIGS. 6-7). The motor pulley 132 may be operably coupled to the arbor pulley 115 such that the arbor pulley 115 rotates as the motor 130 turns the motor pulley 132. The working element 114 may be coupled to an arbor pulley 115. The machining tool 100 may further include one or more intermediate pulleys 134 rotatably mounted to a pivot rod 140 supported by the frame 110. The one or more intermediate pulleys 134 may also be referred to herein as at least one intermediate pulley 134. The machining tool 100 may further include one or more belts 136 coupled between the motor pulley 132, the arbor pulley 115, and the one or more intermediate pulleys 134. The motor 130 may be configured to provide kinetic energy, in the form of rotation, via the motor pulley 132, the arbor pulley 115, the one or more intermediate pulleys 134, and the one or more belts 136 to the working element 114.

The machining tool 100 may further include a hazard mitigation system 150 operatively connected to the working element 114 and configured to interact with the working element 114 to mitigate any safety risk when a dangerous condition is detected. In some embodiments, the hazard mitigation system can be operable to alert an operator of the machining tool 100 of a hazardous situation. The hazard mitigation system 150 may include one or more of an auditory alarm or a visual alarm. In other optional embodiments, the hazard mitigation system 150 can be operable to remove the dangerous condition, when detected, for example, using a reactionary mechanical/electrical/electromechanical mechanism (according to the various systems and methods described herein) operatively coupled to the working element 114 for stopping the working element 114 or retracting the working element 114 beneath or away from the work surface 112 or away from the operator. The hazard detection system 120, while illustrated directly above the working element 114, may alternatively be positioned elsewhere relative to the work surface 112 and/or working element 114.

The machining tool 100 may further include a controller 102 operatively connected to the hazard detection system 120 and the hazard mitigation system 150. The controller 102 may be configured to determine a position and/or movement of the human body part relative to the working element 114 based on outputs from the hazard detection system 120. The controller 102 may further be configured to identify a hazardous situation based on the determined position and/or movement of the human body part relative to the working element 114. The controller 102 may further be configured to activate the hazard mitigation system 150 in response to the identified hazardous situation. The hazardous situation may be based at least in part on the determined position of the human body part being within a predetermined distance from the working element 114. In certain optional embodiments, the predetermined distance may be less than 100 mm, 90 mm, 80 mm, 70 mm, 65 mm, 60 mm, 55 mm, 50 mm, 45 mm, 40 mm, 35 mm, 30 mm, 25 mm, 20 mm, 15 mm, 10 mm, 9 mm, 8 mm, 7 mm, 6 mm, 5 mm, 4 mm, 3 mm, 2 mm, or 1 mm. In certain optional embodiments, the predetermined distance may be greater in front of the working element 114 than beside the working element 114. In other optional embodiments, the hazardous situation may be based at least in part on the determined position of the human body part being within a predefined zone surrounding the working element 114. In some embodiments the zone can extend further in front of the working element 114 as opposed to beside the working element 114, for instance in the case of a circular saw blade where the teeth at the circumferential edges of the saw blade are more dangerous than a side of the saw blade.

The hazardous situation may, in addition to or alternatively, be based at least in part on a determined movement (e.g., direction and rate of speed or velocity) of the human body part relative to the working element 114. In certain optional embodiments, a hazardous situation based on the determined movement may only be realized when the human body part is within the predetermined distance, some other intermediate threshold distance, or the predefined zone. In other optional embodiments, the hazardous situation based on the determined movement may be independent of whether the human body part is within the predetermined distance or the predefined zone.

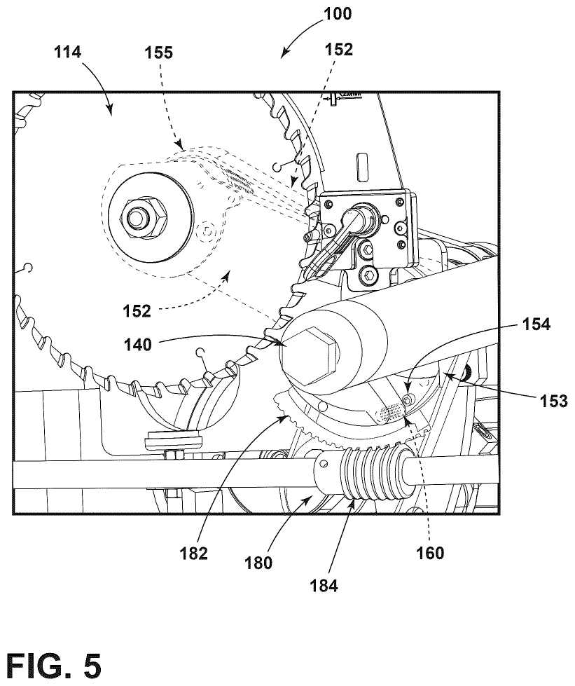

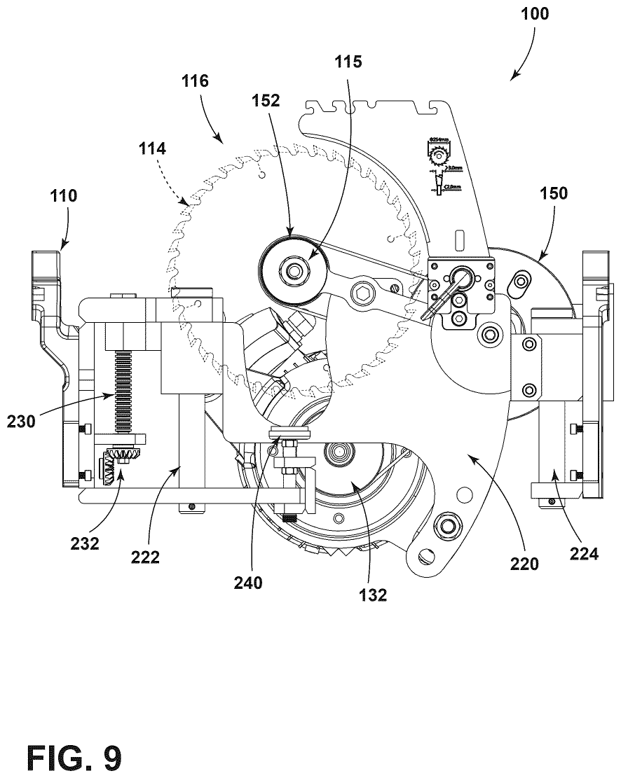

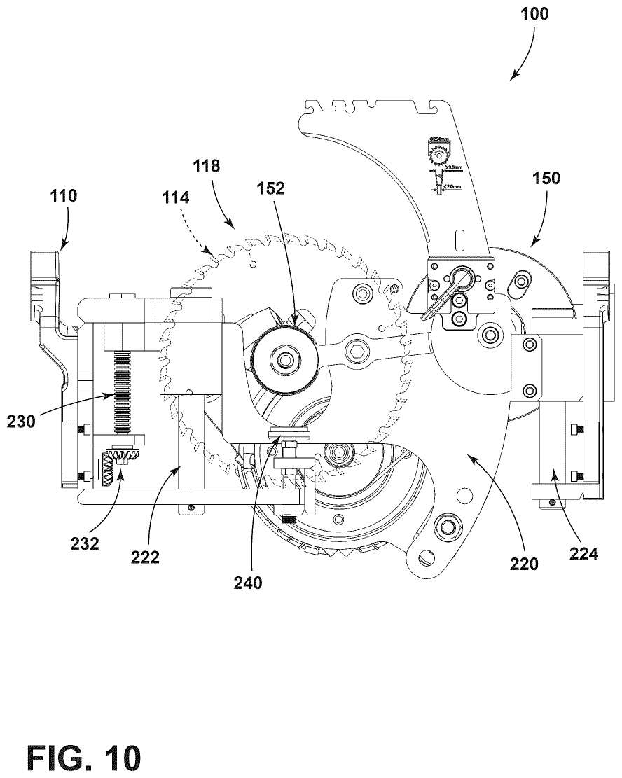

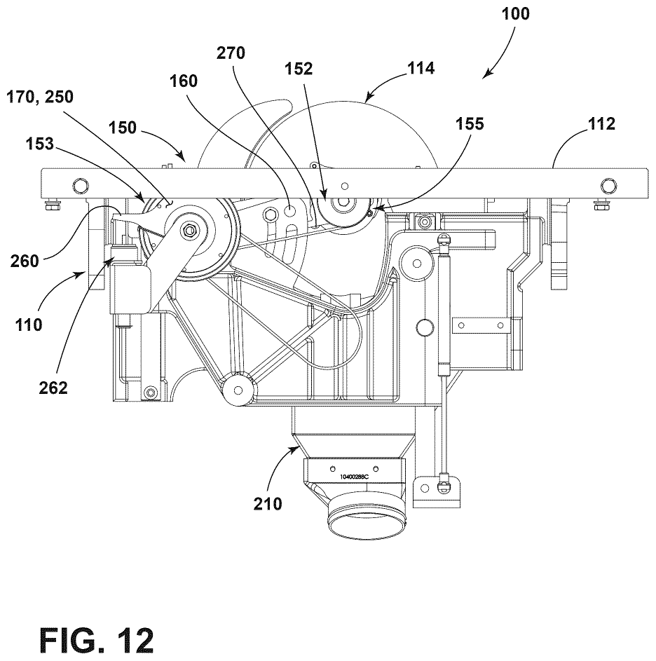

As illustrated in FIGS. 2-13, the hazard mitigation system 150 may include a support arm 152 rotatably coupled to the working element 114 and rotatably coupled to the frame 110 using, for example, the pivot rod 140. The support arm 152 is configured to allow the working element 114 to lower beneath the work surface 112. As illustrated in FIGS. 5 and 12, the hazard mitigation system 150 may further include a retention structure 160 configured to selectively fix a rotational position of the support arm 152 relative to the frame 110 and/or the pivot rod 140. The retention structure 160, when engaged, biases the support arm 152 in a raised rotation position relative to the frame 110 and/or the pivot rod 140. The hazard mitigation system 150 may further include a braking mechanism 170 operable to cause a braking force to be applied on the arbor pulley 115. The braking mechanism 170 may also be referred to herein as a clutch mechanism 170. For example, when the braking force is applied to the arbor pulley 115 while the working element 114 is rotating, the momentum of the rotating working element 114 causes the retention structure 160 to disengage from the support arm 152 or the frame 110 to allow the support arm 152 to rotate and move the working element 114 to a position beneath the work surface 112. As illustrated in FIG. 9, the working element 114 and the support arm 152 are positioned in a deployed position 116. As illustrated in FIG. 10, the working element 114 and the support arm 152 are positioned in a retracted position 118. The deployed position 116 may also be referred to herein as a raised position 116. The retracted position 118 may also be referred to herein as a lowered position 118.

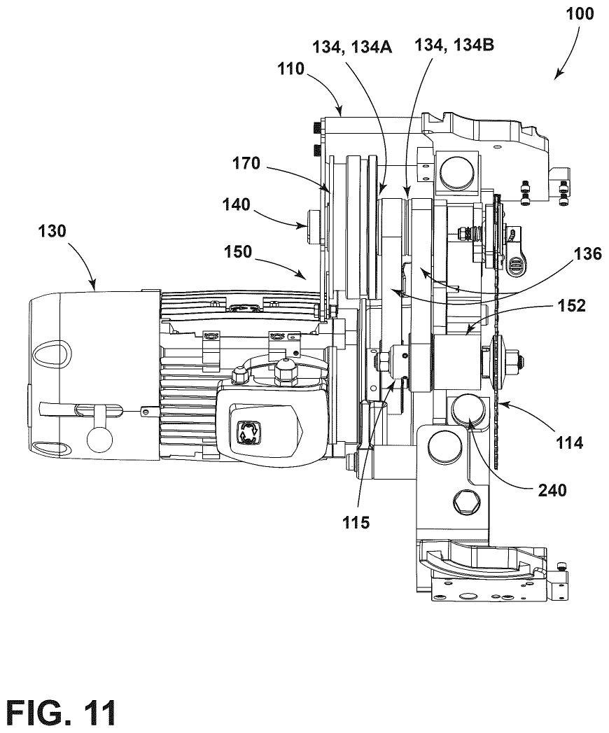

As illustrated in FIG. 11, the one or more intermediate pulleys 134 may comprise a first intermediate pulley 134A engaged with the arbor pulley 115 via one of the one or more belts 136 and a second intermediate pulley 134B engaged with the motor pulley 132 via a different one of the one or more belts 136. The braking mechanism 170 may be a clutch mechanism coupled to the first intermediate pulley 134A and may be operable to move the first intermediate pulley 134A from an engaged position to a disengaged position with respect to the second intermediate pulley 134B and apply a braking force on the first intermediate pulley 134A. In practice, for example, kinetic energy from the working element 114 may be transferred to the support arm 152 using the one or more belts 136 when the clutch mechanism is in a disengaged position and applying a braking force on the first intermediate pulley 134A to move the support arm 152 from the raised position to the lowered position, as illustrated in FIGS. 9 and 10. As such, the clutch mechanism may be configured to selectively engage the first intermediate pulley 134A for disengaging the retention structure 160 and allowing the support arm 152 to rotate about the pivot rod 140 such that the working element 114 moves beneath the work surface 112. As illustrated in FIG. 7, the centrifugal force of the working element 114 acts upon the support arm 152 in response to the one or more belts stopping due to the braking force. In certain optional embodiments, the motor 130 may be disengaged or turned off in response to the braking forcing being applied to the first intermediate pulley 134A. For example, by turning off the motor 130 or separating movement of the first intermediate pulley 134A from the movement of the second intermediate pulley 134B, the braking mechanism 170 more quickly acts upon the arbor pulley 115 to cause the working element 114 to move beneath the work surface 112.

In certain optional embodiments, as illustrated in FIGS. 5 and 12, the retention structure 160 may be disposed on the support arm 152 and may be selectively engageable with the frame 110 (e.g., a hole defined in the frame 110). In other optional embodiments, the retention structure 160 may be disposed on the frame 110 and may be selectively engageable with the support arm 152. In further optional embodiments, as illustrated in FIG. 5, the retention structure 160 may be disposed on the support arm 152 and may be selectively engageable with a worm wheel 182 (as further discussed below) such that the retention structure 160 is engageable with the frame 110 via a worm gear 184. In certain optional embodiments, the retention structure 160 may comprise a steel ball and spring configured to bias the steel ball outwardly. The holding power of the retention structure 160 may be such that when the braking mechanism 170 is engaged, the holding power of the retention structure 160 is overcome. Likewise, the holding power of the retention structure 160 may be such that when the braking mechanism 170 is disengaged, the holding power of the retention structure 160 is strong enough to maintain the rotational position of the support arm 152 relative to the pivot rod 140. In other optional embodiments, the retention structure 160 may take on other forms (e.g., detent mechanisms, cam locks, snap fits, magnetic retention, or the like) and may require physical disengagement using the braking mechanism 170 or some other disengagement mechanism. The support arm 152 may include a proximal end 153 around which the support arm 152 pivots and distal end 155 supporting the working element 114. In certain optional embodiments, as illustrated in FIG. 5, the retention structure 160 may be positioned closer to the proximal end 153 than to the distal end 155. In other optional embodiments, as illustrated in FIG. 12, the retention structure 160 may be positioned closer to the distal end 155 than to the proximal end 153.

As illustrated in FIG. 5, the machining tool 100 may further include a worm gear assembly 180 including a worm wheel 182 and a worm gear 184. The worm wheel 182 may be connected to the pivot rod 140. The worm gear 184 may be configured to engage the worm wheel 182 for adjusting a position of the support arm 152 and a height of the working element 114 relative to the work surface 112. The worm wheel 182 may include an opening 186 that is selectively engageable by the retention structure 160. When the opening 186 is engaged by the retention structure 160, movement of the worm wheel 182 changes position of the support arm 152.

The braking mechanism 170 may be coupled to the pivot rod 140. As illustrated in FIGS. 2-4 and 8-11, the one or more intermediate pulleys 134 may be positioned between braking mechanism 170 and the support arm 152. As illustrated in FIGS. 5-7, the braking mechanism 170 may be positioned between the one or more intermediate pulleys 134 and the support arm 152. In certain optional embodiments, the braking mechanism 170 may comprise an electromagnet brake and operate as a clutch (as discussed above). In other optional embodiments, the braking mechanism 170 may comprise a hydraulic brake, a pneumatic brake, a mechanical brake, a dynamic brake, a hydrostatic brake, an electro-mechanical brake, a friction clutch, a ceramic brake, a viscous brake, a magnetic particle brake, or the like (as discussed below).

As illustrated in FIG. 6 (e.g., normal operation), kinetic energy from the motor is transferred via the motor pulley 132 to the arbor pulley 115 through the one or more intermediate pulleys 134 using the one or more belts 136 (illustrated by the dashed arrows). As illustrated in FIG. 7 (e.g., when the retraction signal is triggered), the braking mechanism 170 acts as a clutch to engage the one or more intermediate pulleys 134 and transfers the kinetic energy from one or both the arbor pulley 115 (e.g., via the working element 114) and the motor pulley 132 to the support arm 152 (illustrated by the dashed arrows). As a result, the retention structure 160 of the support arm 152 disengages thus allowing the support arm 152 to rotate about the pivot rod 140 to retract the working element 114 below the work surface 112. Simultaneously, the working element 114 and the motor 130 come to a stop because the kinetic energy has been transferred to the support arm 152.

The kinetic energy imparted to the hazard mitigation system 150 may be significant as a speed of the working element 114 may reach speeds up to 4500 rpm. The retraction speed may depend upon the performance of the braking mechanism 170. For example, a suitable braking mechanism 170 may be capable of bringing the working element 114 to a position below the work surface 112 in less than 100 ms.

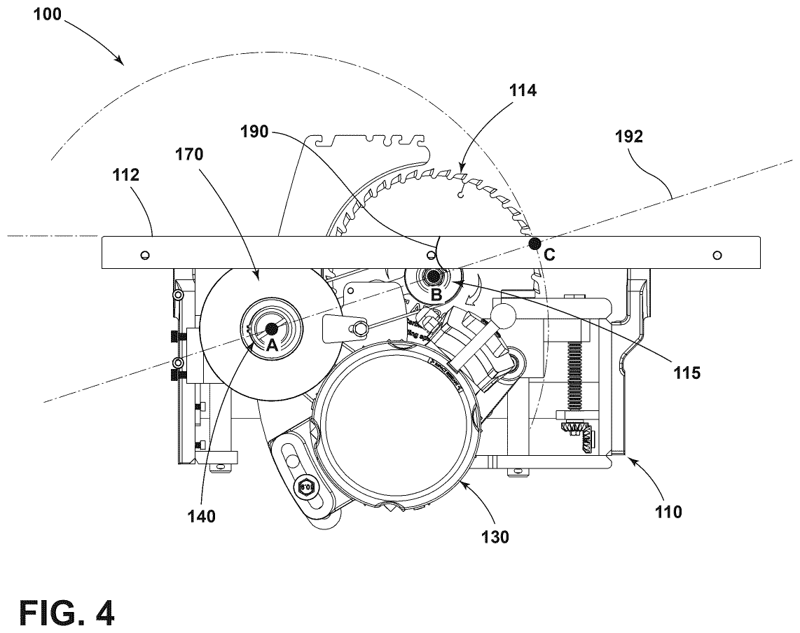

As illustrated in FIG. 4, an angle 190 may be defined between the work surface 112 and a line 192 defined between the arbor pulley 115 and the pivot rod 140. In certain optional embodiments, the angle 190 may be less than or equal to 45 degrees. In other optional embodiments, the angle 190 may be less than or equal to 35 degrees. In other optional embodiments, the angle 190 may be less than or equal to 25 degrees. In other optional embodiments, the angle 190 may be less than or equal to 20 degrees. In other optional embodiments, the angle 190 may be less than or equal to 18 degrees. In other optional embodiments, the angle 190 may be less than or equal to 15 degrees. In other optional embodiments, the angle 190 may be less than or equal to 12 degrees. A point of intersection between the line 192 and an edge of the working element 114 may ideally be lower than the work surface 112 in order to ensure that kinetic energy of the working element 114 causes the working element 114 to move beneath the work surface 112 rather than towards a user.

As illustrated in FIG. 5, the support arm 152 may include a hard stop 154 extending therefrom which may prevent the support arm 152 from pivoting upward when the braking mechanism 170 is engaged. In certain optional embodiments, the hard stop 154 may extend from the frame 110 (or worm wheel 182) and interact with the support arm 152 in order to limit its upward movement. As illustrated, the hard stop 154 interacts with the worm wheel 182, however, in other optional embodiments, the hard stop 154 may interact with the frame 110.

In certain optional embodiments, the frame 110 may be a base of the entire machining tool 100. In other optional embodiments, the frame 110 may comprise a carriage assembly for adjusting a position of the working element 114 relative to the work surface 112. The carriage assembly may enable a height of the working element 114 protruding from the work surface 112 to be adjustable (e.g., via the worm gear assembly 180) or an angle of the working element 114 relative to the work surface 112 to be adjustable. This adjustment may be independent of an angle of the support arm 152.

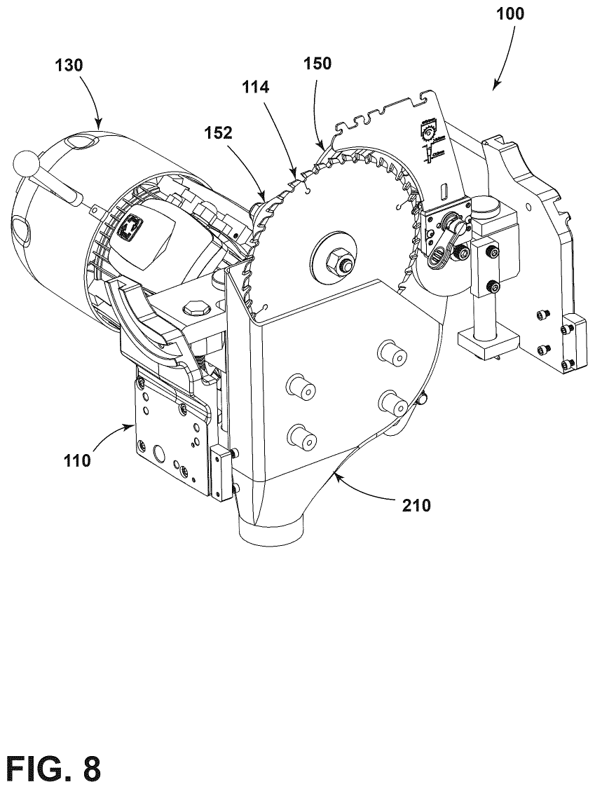

Referring to FIG. 8, the machining tool 100 may further include a dust chute 210. The dust chute 210 may be configured to accommodate the working element 114 when in the deployed position 116 as well as when in the retracted position 118. The dust chute 210 may be configured to help redirect saw dust when ejected from the working element 114 below the work surface 112.

Referring to FIGS. 9 and 10, the motor 130, the pivot rod 140, and the hazard mitigation system 150 may be coupled to a trunnion 220 supported by the frame 110. The trunnion 220 may be coupled to the frame 110 using a first guide pin 222 and a second guide pin 224. The trunnion 220 may be configured to move vertically along the first and second guide pins 222, 224 using a screw 230 and a bevel gear assembly 232. The machining tool 100 may further include a reset stop 240 coupled to the frame 110. As illustrated in FIG. 11, the reset stop 240 may be aligned with the support arm 152.

As illustrated in FIG. 9, the working element 114 is in the deployed position 116, and as illustrated in FIG. 10, the working element 114 is in the retracted position 118. The working element 114 may be reset from the retracted position 118 to the deployed position 116 by lowering the trunnion 220 using the bevel gear assembly 232 and the screw 230 such that the reset stop 240 interacts with a distal end of the support arm 152, thus raising the support arm 152 as the trunnion 220 lowers until the retention structure 160 re-engages. Once the retention structure 160 is engaged, the trunnion 220 may be raised to position the working element 114 back in the deployed position 116. While FIGS. 8-11 illustrate one embodiment for resetting the hazard mitigation system 150, other optional embodiments exist for resetting the hazard mitigation system 150, such as manual resetting or automated mechanical or electromechanical resetting mechanisms, or the like.

In certain optional embodiments, as illustrated in FIGS. 12-18, the braking mechanism 170 may comprise a roller clutch 250 configured to selectively stop rotation of at least one intermediate pulley 134. The roller clutch 250 may include an inner race 252, an outer race 254, and a plurality of rollers 256 positioned between the inner race 252 and the outer race 254. A roller cage 258 may be provided and configured to rotate less than about ten degrees to force the rollers 256 into engagement between the inner race 252 and the outer race 254, thereby producing a rapid self-locking effect that halts rotation of the intermediate pulley 134. In certain optional embodiments, the roller clutch 250 may be replaced with a sprag clutch, or the like

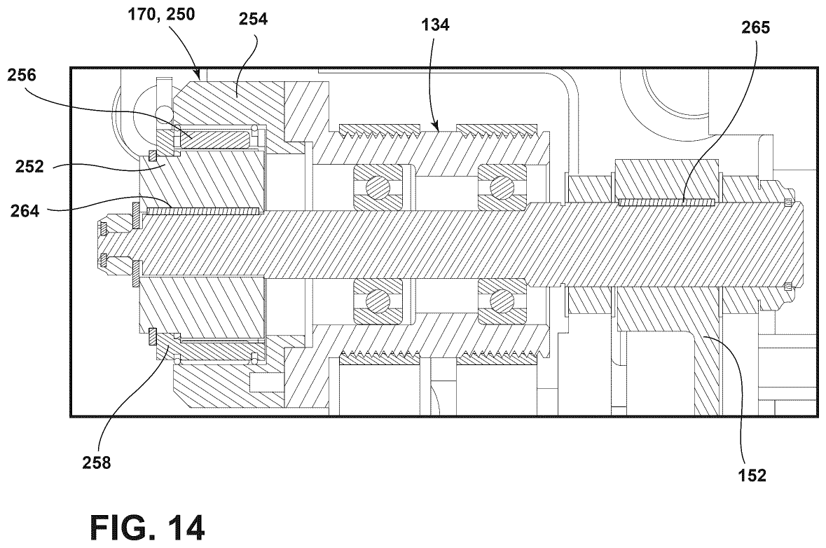

As further illustrated in FIGS. 14-16, the roller clutch 250 may be actuated by a lever 260 operatively coupled to the roller cage 258. A stop 261 may be coupled to the inner race 252 to properly align the roller cage 258 when the roller clutch is in the disengaged position. A solenoid 262 may be supported by the frame 110 and configured to selectively move the lever 260 between a disengaged position, in which the intermediate pulley 134 rotates freely, and an engaged position, in which the intermediate pulley 134 is stopped. In this configuration, the braking mechanism 170 may be controlled with high responsiveness by the solenoid 262.

As illustrated in FIG. 14, the at least one intermediate pulley 134 may be coupled to the outer race 254 of the roller clutch 250. The outer race 254 may be configured to rotate with the at least one intermediate pulley 134. The inner race 252 may be coupled to the pivot rod 140 such that it does not rotate relative to the pivot rod 140. A drive key 264 may be positioned between the pivot rod 140 and the inner race 252 in order to fix the inner race 252 to the pivot rod 140. Similarly, the support arm 152 may be fixed relative to the pivot rod 140 using a second drive key 265. In other optional embodiments, the inner race 252 may be coupled to the pivot rod 140 using a splined connection to improve torque transfer and reduce slippage. Still further optional embodiments may include other coupling arrangements, such as press-fit connections, interference fits, adhesive bonding, or mechanical fasteners, depending on desired load capacity and assembly requirements. As such, when the inner race 252 and the outer race 254 are engaged, the pivot rod 140 may rotates with the support arm 152 and the roller clutch 250 to lower the working element 114. The at least one intermediate pulley 134 may include a first zone for engaging one of the one or more belts 136 leading to the to the motor pulley 132 and a second zone for engaging a different one of the one or more belts 136 leading to the arbor pulley 115.

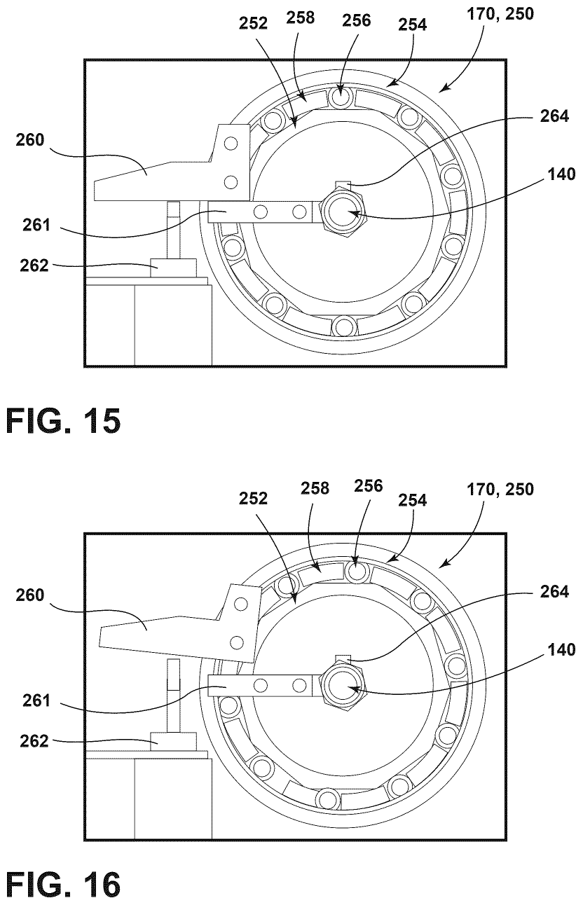

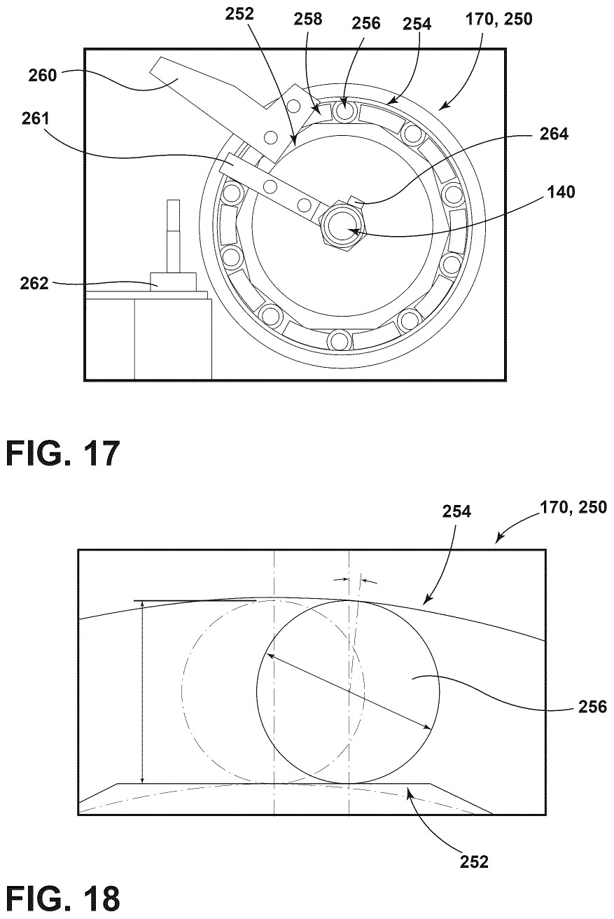

As illustrated in FIG. 15, the outer race 254 is freely rotatable about the inner race 252 (e.g., not coupled) since the lever 260 and associated roller cage 258 is in a disengaged position. This represents the normal operating condition, wherein the working element 114 is positioned at least partially above the work surface 112. When a hazard is detected, as illustrated in FIG. 16, the solenoid 262 moves the lever 260 and associated roller cage 258 and plurality of rollers 256 to cause the inner race 252 and the outer race 254 to lock in a fixed configuration on the pivot rod 140. This represents the moment the brake is applied just prior to a lowering of the support arm 152. As illustrated in FIG. 17, the roller clutch 250 along with the support arm 152 and the pivot rod 140 rotate in unison to retract the working element 114 below the work surface 112. The working element 114 may be reset to the normal operating condition, after the retraction shown in FIG. 17, by raising the support arm 152 to its initial raised position with the working element 114 positioned at least partially above the work surface 112. As such, the roller clutch 250 is operable to selectively transfer rotational kinetic energy of the working element 114 and/or the motor 130 to the support arm 152 via engagement of the roller clutch 250 to overcome the retention structure 160 and cause the support arm 152 to pivot such that the working element 114 retracts beneath the work surface 112.

Referring to FIG. 18, the interaction between the inner race 252 and the outer race 254, based on a repositioning of one or more of the plurality of rollers 256, is shown in greater detail. When the solenoid 262 is actuated, the roller cage 258 is caused to rotate approximately 5-6 degrees relative to the inner race 252. This small angular displacement forces the rollers 256 into engagement between the inner race 252 and the outer race 254. As the rollers wedge between the races, the clutch transitions from a freewheeling state to a locked configuration. Due to the optimized geometry of the rollers 256 and the small friction angle of the contact surfaces, a self-locking effect may be produced that immediately halts rotation of the outer race 254. In certain embodiments, the locking action occurs in less than about 1-2 milliseconds. The sudden stoppage of the outer race 254 transfers the rotational kinetic energy of the working element 114 and/or arbor pulley 115 through the pivot rod 140 into the support arm 152, thereby driving the support arm 152 downward to rapidly retract the working element 114 beneath the work surface 112. In this manner, the roller clutch may provide both rapid engagement and efficient conversion of stored kinetic energy into mechanical motion for hazard mitigation.

As illustrated in FIG. 12, the support arm 152 may include a shock absorber 270 positioned on a bottom surface of the support arm 152. The shock absorber 270 may interact with the frame 110 when the support arm 152 moves from the raised position to the lowered position to prevent rebounding of the support arm 152 due to its interaction with the frame 110. In certain optional embodiments, the shock absorber 270 may be made of viscoelastic or non-Newtonian materials, such as, for example, a shear-thickening polymer such as RHEON®, which stiffens upon high-strain impact to absorb and dissipate vibrational energy. In other optional embodiments, the shock absorber 270 may comprise an elastomeric bumper, a polyurethane pad, or a silicone gel insert configured to deform upon impact and return to its original shape without permanent deformation. In further optional embodiments, the shock absorber 270 may include a spring-damper cartridge, a pneumatic or hydraulic cylinder, or a magnetorheological damper that dynamically adjusts resistance based on applied force. In yet other embodiments, the shock absorber 270 may be integrally formed as part of the support arm 152 or the frame 110, or may be removably mounted to facilitate replacement or adjustment of damping characteristics depending on the desired retraction speed and impact force.

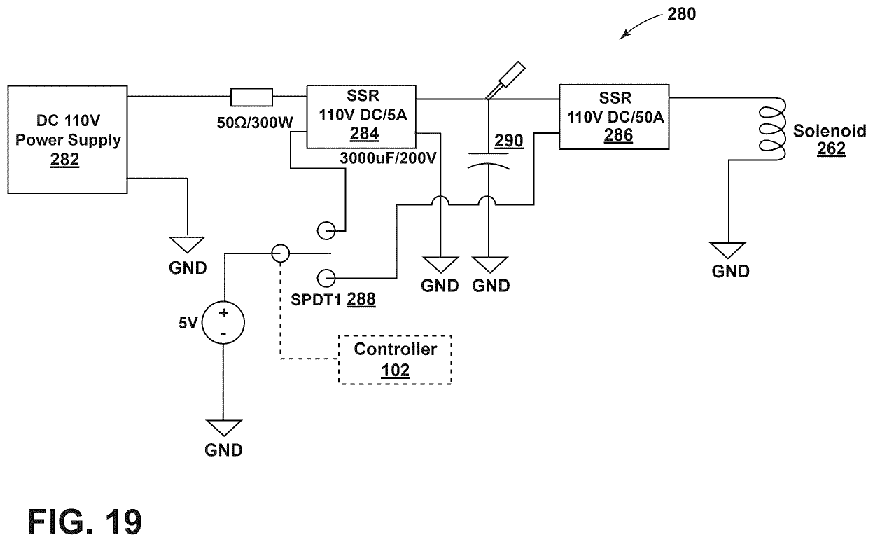

Referring to FIG. 19, the solenoid 262 may be electrically connected to a capacitor discharge circuit 280. The capacitor discharge circuit 280 may be configured to momentarily overdrive the solenoid 262, such that the engagement time of the roller clutch 250 is reduced to less than about 15 milliseconds. For example, overdriving the solenoid 262 may reduce an actuation time from approximately 24 milliseconds to approximately 11 milliseconds, ensuring that the braking mechanism 170 is engaged quickly enough to stop and retract the working element 114 in less than 100 milliseconds total system response time.

The capacitor discharge circuit 280 may include a DC 110V power supply 282, a first solid-state relay (SSR) 284 rated at 110 VDC/5 A, and a second SSR 286 rated at 110 VDC/50 A. The power supply 282 provides the necessary voltage to actuate the braking mechanism 170, such as the solenoid 262 configured to engage the roller clutch 250. The controller 102 may control a switch 288 which may selectively enable either the first SSR 284 or the second SSR 286. The first SSR 284 may be utilized to charge a capacitor 290 while the second SSR 286 may control discharge of the capacitor 290 for quick actuation of the solenoid 262. By incorporating the capacitor 290 in conjunction with the higher powered second SSR 286, an activation time of the solenoid 262 is reduced.

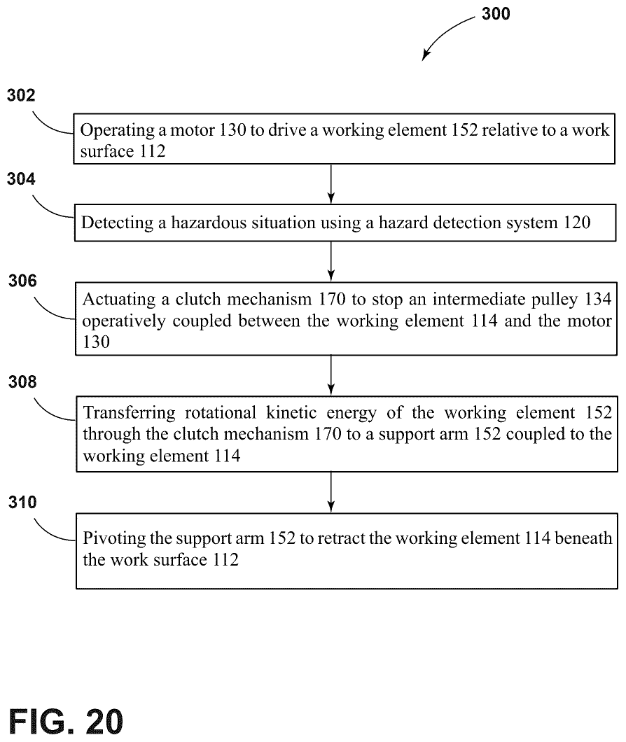

Referring to FIG. 20, a method 300 of mitigating hazards in a machining tool is provided. The method 300 may include operating 302 a motor 130 to drive a working element 114 relative to a work surface 112. The method 300 may further include detecting 304 a hazardous situation using a hazard detection system 120. The method 300 may further include actuating 306 a clutch mechanism 170 to stop an intermediate pulley 134 operatively coupled between the working element 114 and the motor 130. The method 300 may further include transferring 308 rotational kinetic energy of the working element 114 through the clutch mechanism 170 to a support arm 152 coupled to the working element 114. The method 300 may further include pivoting 310 the support arm 152 to retract the working element 114 beneath the work surface 112.

In certain optional aspects of the method 300, the support arm 152 may be biased in the deployed position 116 by a retention structure 160 comprising a ball-and-spring mechanism, and pivoting the support arm 152 may include overcoming the retention structure 160 to release the support arm 152. In additional aspects, actuating the clutch mechanism 170 may include energizing a solenoid 262 connected to a lever 260 of a roller clutch 250 to move the roller clutch 250 between a disengaged and an engaged position relative to the intermediate pulley 134.

In still further aspects of the method 300, energizing the solenoid 262 may include overdriving the solenoid using a capacitor discharge circuit 280 to accelerate engagement of the clutch mechanism 170. In some embodiments, the method 300 may also include resetting the support arm 152 from the retracted position 118 to the deployed position 116. The method 300 may further include additional method steps as necessitated based on the above description without departing from the scope of the present disclosure.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A machining tool comprising:
a frame;
a work surface positioned above the frame;
a working element positioned adjacent to the work surface;
a motor supported by the frame and operatively connected to the working element; and
a hazard mitigation system including:
a support arm rotatably coupled to the working element and pivotally coupled to the frame, the support arm configured to allow the working element to retract beneath the work surface;
a retention structure configured to bias the support arm in a deployed position relative to the frame; and
a braking mechanism operable to selectively transfer rotational kinetic energy of the working element and/or the motor to the support arm, wherein engagement of the braking mechanism overcomes the retention structure and causes the support arm to pivot such that the working element retracts beneath the work surface.

2. The machining tool of claim 1, further comprising:
a pivot rod coupled to the frame, wherein the support arm is rotatably disposed on the pivot rod and the braking mechanism is disposed on the pivot rod.

3. The machining tool of claim 2, further comprising:
an arbor pulley coupled to the working element;
a motor pulley coupled to the working element;
at least one intermediate pulley rotatably mounted to the pivot rod; and
one or more belts coupled between the motor pulley, the arbor pulley, and the at least one intermediate pulley.

4. The machining tool of claim 3, wherein:
the at least one intermediate pulley is coupled to the braking mechanism; and
rotation of the at least one intermediate pulley is controlled by the braking mechanism.

5. The machining tool of claim 4, wherein:
the at least one intermediate pulley is rotatable about the pivot rod when the braking mechanism is in a disengaged position; and
the at least one intermediate pulley is fixed relative to the pivot rod when the braking mechanism is in an engaged position.

6. The machining tool of claim 3, wherein:
the braking mechanism comprises an electromagnetic clutch, roller clutch, or sprag clutch disposed on the pivot rod and configured to engage the at least one intermediate pulley to release the retention structure and permit rotation of the support arm.

7. The machining tool of claim 1, further comprising:
a hazard detection system operable to track a position of a human body part relative to the working element; and
a controller operatively connected to the hazard mitigation system and the hazard detection system, the controller configured to:
identify a hazardous situation based on outputs from the hazard detection system; and
actuate the hazard mitigation system in response to the identified hazardous situation.

8. The machining tool of claim 1, wherein:
the retention structure is a ball-and-spring mechanism.

9. The machining tool of claim 1, wherein:
the support arm includes a proximal end around which the support arm pivots and a distal end supporting the working element; and
the retention structure is coupled closer to the distal end than to the proximal end.

10. The machining tool of claim 1, wherein:
the support arm rotates less than thirty degrees (30°) between the deployed position and a retracted position.

11. The machining tool of claim 1, wherein the braking mechanism includes:
a roller clutch configured to selectively stop rotation of at least one intermediate pulley;
a lever coupled to the roller clutch and configured to selectively engage the roller clutch for stopping the at least one intermediate pulley; and
a solenoid coupled to the frame and configured to selectively engage the lever to control the roller clutch between an engaged position and a disengaged position.

12. The machining tool of claim 11, wherein:
the at least one intermediate pulley is freely rotatable when the roller clutch is in the disengaged position and is stopped when the roller clutch is in the engaged position.

13. The machining tool of claim 11, wherein the roller clutch includes:
an inner race;
an outer race;
a plurality of rollers positioned between the inner race and the outer race; and
a roller cage configured to rotate less than about ten degrees to force the plurality of rollers into engagement between the inner race and the outer race.

14. A hazard mitigation assembly for a machining tool, comprising:
a pivot rod configured to be supported by a frame;
a support arm rotatably mounted on the pivot rod and configured to carry a working element;
a retention structure configured to bias the support arm in a deployed position relative to the frame;
a clutch mechanism disposed on the pivot rod and coupled to at least one intermediate pulley operatively coupled to the working element; and
an actuator operable to engage the clutch mechanism to stop rotational movement of the at least one intermediate pulley such that rotational kinetic energy of the working element is transferred to the support arm to overcome the retention structure and pivot the support arm to a retracted position.

15. The hazard mitigation assembly of claim 14, wherein:
the clutch mechanism comprises a roller clutch including an inner race, an outer race, and a roller cage configured to shift less than ten degrees to force rollers into engagement between the inner race and the outer race.

16. The hazard mitigation assembly of claim 14, wherein:
the actuator comprises a solenoid operatively connected to a lever coupled to the clutch mechanism, the solenoid configured to move the lever for controlling the clutch mechanism between a disengaged position in which the at least one intermediate pulley rotates freely and an engaged position in which the at least one intermediate pulley is stopped.

17. The hazard mitigation assembly of claim 16, further comprising:
a capacitor discharge circuit electrically connected to the solenoid and configured to momentarily overdrive the solenoid to reduce an engagement time of the clutch mechanism to less than 15 milliseconds.

18. A method of mitigating hazards in a machining tool, comprising:
operating a motor to drive a working element relative to a work surface;
detecting a hazardous situation using a hazard detection system;
actuating a clutch mechanism to stop an intermediate pulley of the machining tool, the intermediate pulley operatively coupled between the working element and the motor;
transferring rotational kinetic energy of the working element through the clutch mechanism to a support arm, the support arm coupled to the working element; and
pivoting the support arm to retract the working element beneath the work surface.

19. The method of claim 18, wherein:
the support arm is biased in a deployed position by a retention structure comprising a ball-and-spring mechanism, and pivoting the support arm comprises overcoming the retention structure to release the support arm.

20. The method of claim 18, wherein:
actuating the clutch mechanism comprises energizing a solenoid operatively connected to a lever of a roller clutch to move the roller clutch between a disengaged position and an engaged position relative to the intermediate pulley.
